(19) United States
(12) Patent Application Publication
(10) Pub. No.: US 2007/0263716 A1
(43) Pub. Date: Nov. 15, 2007

(54) Digital video broadcasting method for updating firmware image of digital set-top box or digital television

(75) Inventors: Wen-Jen Huang, Hsinhua (TW); Ching-Kwei Hsu, Hsinhua (TW); Shu-Ming Liu, Hsinhua (TW)

Correspondence Address: John Chen, Room 303, 3F, No 25, Sec. 1, Changan E. Road, Taipei, 10441, TW

(73) Assignee: Himax Technologies, Inc., Hsinhua (TW)

(21) Appl. No.: 11/430,980

(22) Filed: May 10, 2006

(51) Int. Cl. H04N 7/173; H04B 1/66

(52) U.S. Cl. 375/240; 725/105

(57) ABSTRACT

The present invention provides a digital video broadcasting method for updating a firmware image of a device, comprising providing at least two versions of a firmware image, extracting at least one firmware image difference according to the difference between said at least two versions of a firmware image, transmitting a basic version of said at least two versions of said firmware image and said at least one firmware image difference from a regional head end through DVB standard, and updating said firmware image of said device by said basic version of said at least two versions of said firmware image and said at least one firmware image difference.

### BACKGROUND OF THE PRESENT INVENTION

1. Field of Invention

The present invention relates to a digital video broadcasting method and in particular to a digital video broadcasting method for updating a firmware image of a digital set-top box or a digital television.

2. Description of Related Arts

Digital Video Broadcasting (DVB) standards will become overriding for transmission of digital television signals in most of the world. This will require that all consumer households purchase new digital televisions or digital set-top boxes which allow the old fashioned analog televisions to convert or descramble the incoming digital signals to analog signals for viewing.

The firmware image update of the digital set-top box or the digital television is transmitted through DVB-DATA standard. The local or regional head end always continuously transmits different versions of firmware images of the digital set-top box or the digital television, which may need a large bandwidth for the transmission of the different versions of firmware images of the digital set-top box or the digital television. However, most amount of the bandwidth is utilized to transmit digital audios, graphics and videos, only leaving a small bandwidth for the transmission of the different versions of firmware images of the digital set-top box or the digital television.

Accordingly, it would be advantageous to have an improved digital video broadcasting method for updating a firmware image of a digital set-top box or a digital television.

### SUMMARY OF THE PRESENT INVENTION

A main object of the present invention is to provide a digital video broadcasting method utilizing firmware image differences derived from different versions of firmware images transmitted from the local or regional head end through DVB standard to efficiently update a digital television (DTV) firmware image of a digital set-top box or a digital television.

Another object of the present invention is to provide a digital video broadcasting method utilizing firmware image differences derived from different versions of firmware images transmitted at regular scheduled time intervals to efficiently update a digital television (DTV) firmware image of a digital set-top box or a digital television.

Accordingly, in order to accomplish the above objects, the present invention provides a digital video broadcasting method for updating a firmware image of a device, comprising:

providing at least two versions of a firmware image;

extracting at least one firmware image difference according to the difference between said at least two versions of a firmware image;

transmitting a basic version of said at least two versions of said firmware image and said at least one firmware image difference from a regional head end through DVB standard; and

updating said firmware image of said device by said basic version of said at least two versions of said firmware image and said at least one firmware image difference.

These and other objectives, features, and advantages of the present invention will become apparent from the following detailed description, the accompanying drawings, and the appended claims.

### BRIEF DESCRIPTION OF THE DRAWINGS

FIGS. 1A˜1C are schematic diagrams of firmware image difference extraction according to a preferred embodiment of the present invention.

FIGS. 2A˜2D are schematic diagrams of firmware image update mechanism according to the above-preferred embodiment of the present invention.

### DETAILED DESCRIPTION OF THE PREFERRED EMBODIMENT

In the following detailed description of the present invention, numerous specific details are set forth in order to provide a thorough understanding of the present invention. However, it will be obvious to one skilled in the art that the present invention may be practiced without these specific details. In other instances well known methods, procedures, components, and circuits have not been described in detail so as not to unnecessarily obscure aspects of the present invention.

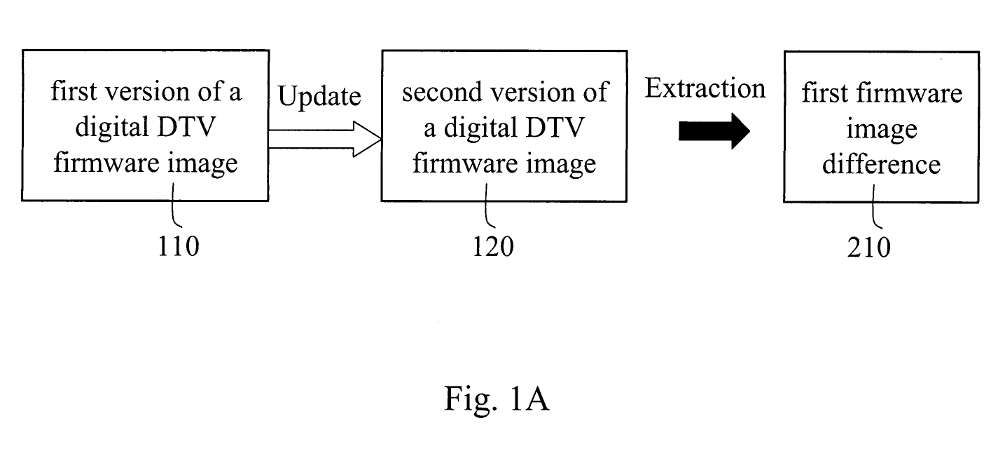

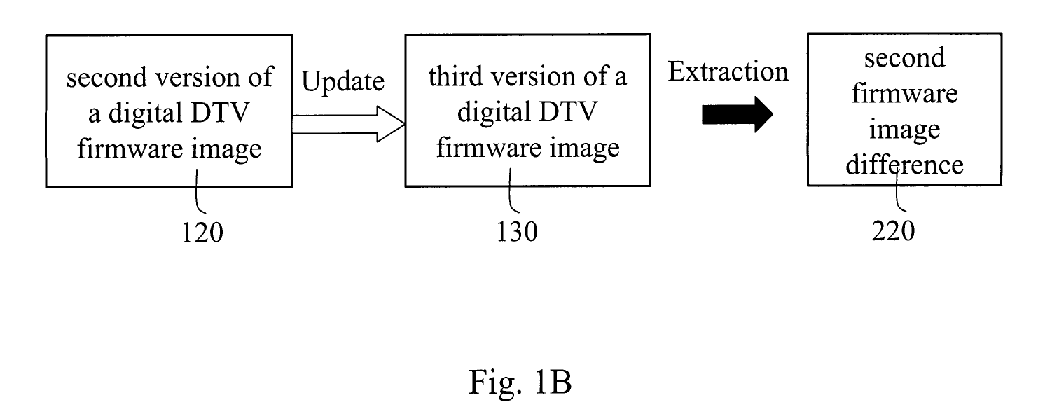

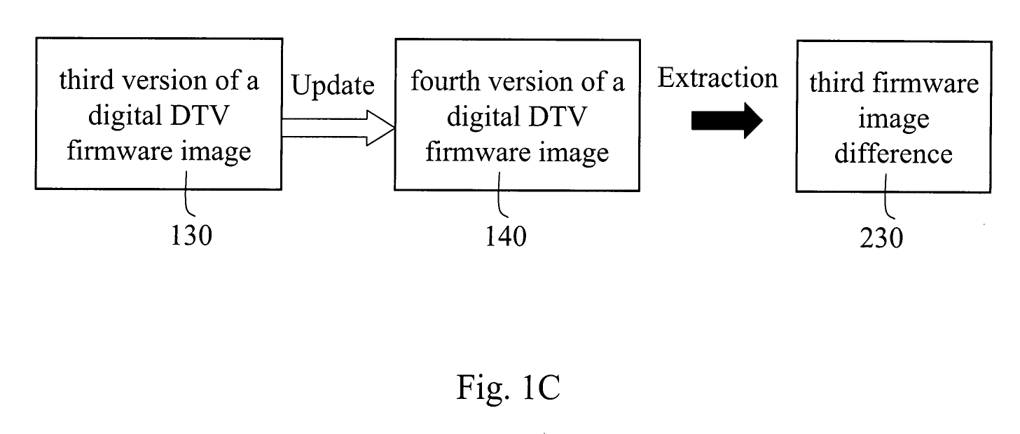

Referring to FIGS. 1A˜1C of the drawings, which are schematic diagram of firmware image difference extraction according to a preferred embodiment of the present invention. As shown in FIG. 1A, according to a difference of a first version of a digital television (DTV) firmware image 110 and a second version of the digital television (DTV) firmware image 120, a first firmware image difference 210 could be extracted. Similarly, as shown in FIG. 1B, according to a difference of the second version of the digital television (DTV) firmware image 120 and a third version of the digital television (DTV) firmware image 130, a second firmware image difference 220 could be extracted. As shown in FIG. 1C, according to a difference of the third version of the digital television (DTV) firmware image 130 and a fourth version of the digital television (DTV) firmware image 140, a third firmware image difference 230 could be extracted.

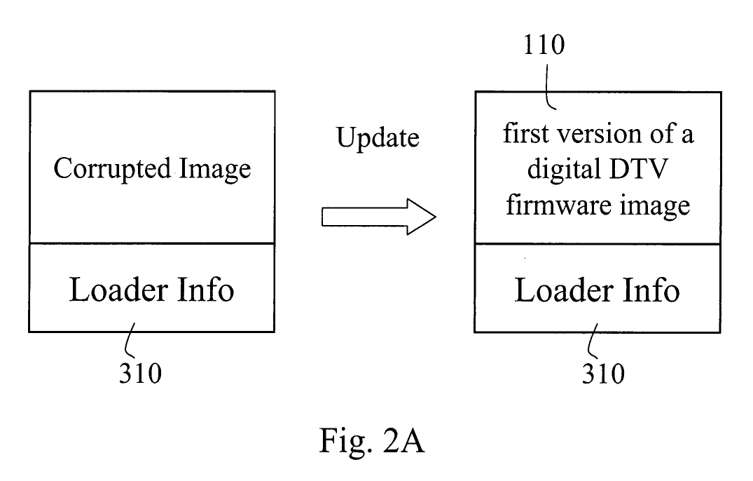

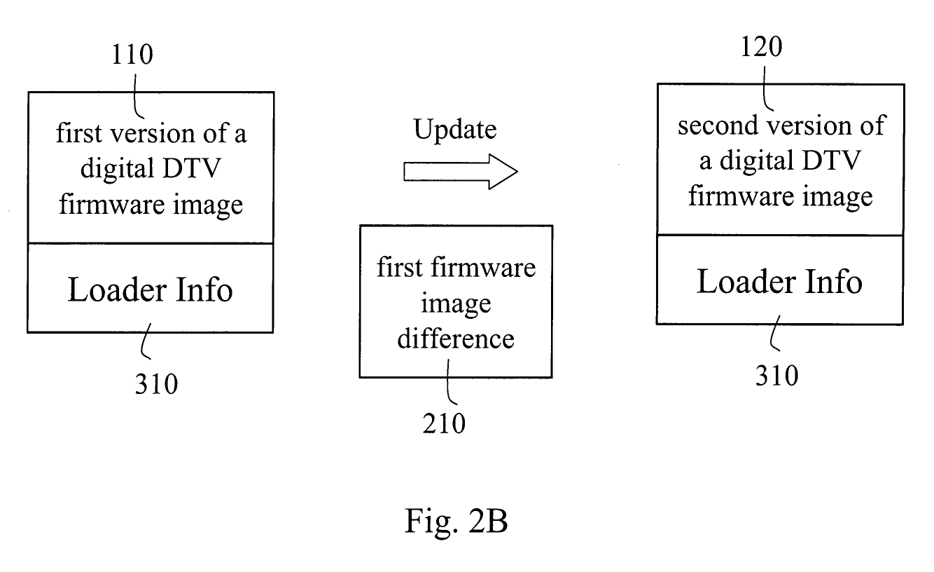

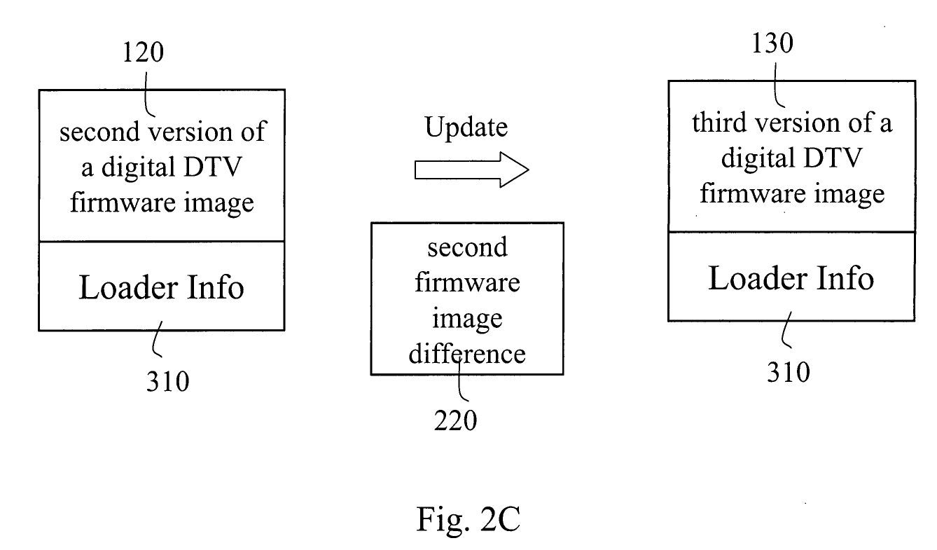

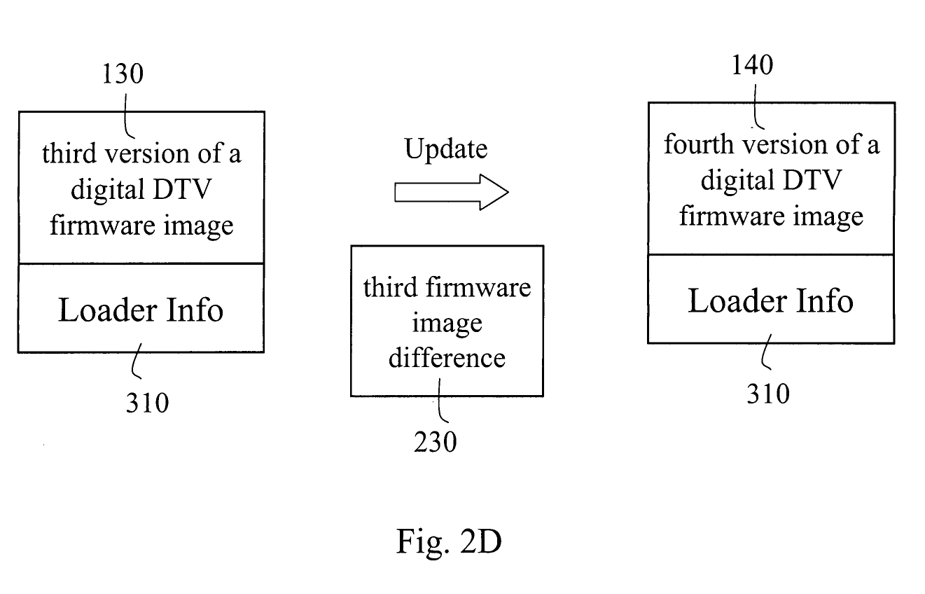

A digital set-top box or a digital television contains a loader information 310 stored in a memory inside the digital set-top box or the digital television. The loader information 310 comprises a manufacture ID, a model ID, a version number, . . . , etc. of the digital set-top box or the digital television. Referring to FIGS. 2A˜2D of the drawings, which are schematic diagrams of firmware image update mechanism according to the above-preferred embodiment of the present invention. As shown in FIG. 2A, when a loader information 310 is loaded in a digital set-top box or a digital television and a firmware image is unloaded in the digital set-top box or the digital television, the digital set-top box or the digital television utilizes the loader information 310 to decide which version of the digital television (DTV) firmware image or firmware image difference could be loaded such that the digital set-top box or the digital television receives the first version of the digital television (DTV) firmware image 110 from the local or regional head end through DVB standard.

Similarly, as shown in FIG. 2B, the first version of the digital television (DTV) firmware image 110 is updated to. the second version of the digital television (DTV) firmware image 120. The digital set-top box or the digital television utilizes the loader information 310 to decide which version of the digital television (DTV) firmware image or firmware image difference could be loaded. The digital set-top box or the digital television needs not to reload the whole second version of the digital television (DTV) firmware image 120. The present invention utilizes the first firmware image difference 210 to update the first version of the digital television (DTV) firmware image 110 to the second version of the digital television (DTV) firmware image 120. Hence the digital set-top box or the digital television receives the first firmware image difference 210 from the local or regional head end through DVB standard to update the first version of the digital television (DTV) firmware image 110 to the second version of the digital television (DTV) firmware image 120.

As shown in FIG. 2C, the second version of the digital television (DTV) firmware image 120 is updated to the third version of the digital television (DTV) firmware image 130. The digital set-top box or the digital television utilizes the loader information 310 to decide which version of the digital television (DTV) firmware image or firmware image difference could be loaded. The digital set-top box or the digital television needs not to reload the whole third version of the digital television (DTV) firmware image 130. The present invention utilizes the second firmware image difference 220 to update the second version of the digital television (DTV) firmware image 120 to the third version of the digital television (DTV) firmware image 130. Hence the digital set-top box or the digital television receives the second firmware image difference 220 from the local or regional head end through DVB standard to update the second version of the digital television (DTV) firmware image 120 to the third version of the digital television (DTV) firmware image 130.

As shown in FIG. 2D, the third version of the digital television (DTV) firmware image 130 is updated to the fourth version of the digital television (DTV) firmware image 140. The digital set-top box or the digital television utilizes the loader information 310 to decide which version of the digital television (DTV) firmware image or firmware image difference could be loaded. The digital set-top box or the digital television needs not to reload the whole fourth version of the digital television (DTV) firmware image 140. The present invention utilizes the third firmware image difference 230 to update the third version of the digital television (DTV) firmware image 130 to the fourth version of the digital television (DTV) firmware image 140. Hence the digital set-top box or the digital television receives the third firmware image difference 230 from the local or regional head end through DVB standard to update the third version of the digital television (DTV) firmware image 130 to the fourth version of the digital television (DTV) firmware image 140.

From the forgoing descriptions, it can be shown that if the second version of the digital television (DTV) firmware image 120 would like to be updated to the fourth version of the digital television (DTV) firmware image 140, the digital set-top box or the digital television have to receive the second firmware image difference 220 to update the second version of the digital television (DTV) firmware image 120 to the third version of the digital television (DTV) firmware image 130 and then receives the third firmware image difference 230 to update the third version of the digital television (DTV) firmware image 130 to the fourth version of the digital television (DTV) firmware image 140.

Furthermore, at regular scheduled time intervals the first version of the digital television (DTV) firmware image and each of the firmware image differences could be transmitted to the digital set-top box or the digital television from the local or regional head end through DVB standard. Hence the bandwidth for the transmission of the first version of the digital television (DTV) firmware image and each of the firmware image differences could be further reduced. For example, the first version of the digital television (DTV) firmware image 110 could be transmitted one time from the local or regional head end through DVB standard per day. The first firmware image difference 210 could be transmitted one time from the local or regional head end through DVB standard per 12 hours. The second firmware image difference 220 could be transmitted one time from the local or regional head end through DVB standard per 6 hours. The third firmware image difference 230 could be transmitted one time from the local or regional head end through DVB standard per hour. Any firmware image difference could be transmitted for one hour per time. Furthermore, a data carousel architecture may be also incorporated to reduce the bandwidth for the transmission of the first version of the digital television (DTV) firmware image and each of the firmware image differences. In this case, for example, per day, the first version of the digital television (DTV) firmware image 110, the first firmware image difference 210, the second firmware image difference 220, and the third firmware image difference 230 may share 10%, 20%, 30%, and 40% of the transmission; per 12 hours, the first version of the digital television (DTV) firmware image 110, the first firmware image difference 210, the second firmware image difference 220, and the third firmware image difference 230 may share 0%, 20%, 30%, and 50% of the transmission; per 6 hours, the first version of the digital television (DTV) firmware image 110, the first firmware image difference 210, the second firmware image difference 220, and the third firmware image difference 230 may share 0%, 0%, 40%, and 60% of the transmission; and per hour, the first version of the digital television (DTV) firmware image 110, the first firmware image difference 210, the second firmware image difference 220, and the third firmware image difference 230 may share 0%, 0%, 0%, and 100% of the transmission.

From the forgoing descriptions, the rough efficiency and reduction of byte rate can be shown as follows. Assume the size of the first version of the digital television (DTV) firmware image 110 is 10000 bytes, the size of the first firmware image difference 210 is 1000 bytes, the size of the second firmware image difference 220 is 100 bytes, and the size of the third firmware image difference 230 is 10 bytes. If four versions of the digital television (DTV) firmware images are averagely transmitted from the local or regional head end through DVB standard per hour, the average byte rate is 10802 (i.e. (10000+11000+11100+11110)/4=10802). If the first version of the digital television (DTV) firmware image, the first firmware image difference, the second firmware image difference, and the third firmware image difference are averagely transmitted from the local or regional head end through DVB standard per hour, the average byte rate is 2777 (i.e. (10000+1000+100+10)/4=2777). If the first version of the digital television (DTV) firmware image is transmitted one time per day, the first firmware image difference is transmitted one time per 12 hours, the second firmware image difference is transmitted one time per 6 hours, and the third firmware image difference is transmitted one time per hour, the average byte rate is reduced to 523 bytes, i.e.,
10000*1+1000*2+100*4+10*17)/24=523

Also, if the first version of the digital television (DTV) firmware image and three firmware image differences are transmitted as the data carousel architecture previously exemplified, the average byte rate is further reduced to 0.88 bytes, i.e.,
[(10000*0.1+1000*0.2+100*0.3+10*0.4)*1+(1000*0.2+100*0.3+10*0.5)+(100*0.4+10*0.6)+10*17]/24=88

From the forgoing descriptions, it can be shown that the above objects have been substantially achieved. The present invention effectively provides a digital video broadcasting method utilizing firmware image differences derived from different versions of firmware images transmitted at regular scheduled time intervals to efficiently update a digital television (DTV) firmware image of a digital set-top box or a digital television. Because the size of the firmware image differences compared with any versions of a DTV firmware image is small, there is a little amount of bandwidth utilized to update the different versions of firmware images of the digital set-top box or the digital television.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A digital video broadcasting method for updating a firmware image of a device, comprising:
providing a first version of a firmware image and a second version of said firmware image;
extracting a firmware image difference according to the difference between said first version of said firmware image and said second version of said firmware image;
transmitting said first version of said firmware image and said firmware image difference from a regional head end through DVB standard; and
updating said firmware image of said device by said first version of said firmware image and said firmware image difference.

2. The digital video broadcasting method, as recited in claim 1, wherein said device is one of a digital set-top box and a digital television.

3. The digital video broadcasting method, as recited in claim 1, wherein said first version of a firmware image and said second version of said firmware image are digital television (DTV) firmware images.

4. The digital video broadcasting method, as recited in claim 2, wherein said first version of a firmware image and said second version of said firmware image are digital television (DTV) firmware images.

5. The digital video broadcasting method, as recited in claim 1, wherein said device contains a loader information stored in a memory inside said device, which is utilized to decide which version of said firmware image or firmware image difference is to be loaded.

6. The digital video broadcasting method, as recited in claim 4, wherein said device contains a loader information stored in a memory inside said device, which is utilized to decide which version of said firmware image or firmware image difference is to be loaded.

7. The digital video broadcasting method, as recited in claim 1, wherein at regular scheduled time intervals said first version of said firmware image and said firmware image difference are transmitted from a regional head end through DVB standard.

8. The digital video broadcasting method, as recited in claim 6, wherein at regular scheduled time intervals said first version of said firmware image and said firmware image difference are transmitted from a regional cable head end through DVB standards.

9. The digital video broadcasting method, as recited in claim 1, wherein at regular scheduled time intervals of said first version of said firmware image and said firmware image difference are transmitted according to a predetermined data carousel architecture from a regional head end through DVB standard.

10. The digital video broadcasting method, as recited in claim 8, wherein at regular scheduled time intervals said first version of said firmware image and said firmware image difference are transmitted according to a predetermined data carousel architecture from a regional head end through DVB standards.

11. A digital video broadcasting method for updating a firmware image of a device, comprising:
providing at least two versions of firmware images;
extracting at least one firmware image difference according to the difference between said at least two versions of firmware images;
transmitting a basic version of said at least two versions of said firmware image and said at least one firmware image difference from a regional head end through DVB standard; and
updating said firmware image of said device by said basic version of said at least two versions of firmware images and said at least one firmware image difference.

12. The digital video broadcasting method, as recited in claim 11, wherein said device is one of a digital set-top box and a digital television.

13. The digital video broadcasting method, as recited in claim 11, wherein a first version of firmware image and a second version of firmware image are digital television (DTV) firmware images.

14. The digital video broadcasting method, as recited in claim 12, wherein a first version of firmware image and a second version of firmware image are digital television (DTV) firmware images.

15. The digital video broadcasting method, as recited in claim 11, wherein said device contains a loader information stored in a memory inside said device, which is utilized to decide which version of said firmware image or firmware image difference is to be loaded.

16. The digital video broadcasting method, as recited in claim 14, wherein said device contains a loader information stored in a memory inside said device, which is utilized to decide which version of said firmware image or firmware image difference is to be loaded.

17. The digital video broadcasting method, as recited in claim 11, wherein at regular scheduled time intervals said basic version of said at least two versions of said firmware image and said at least one firmware image difference are transmitted from a regional head end through DVB standard.

18. The digital video broadcasting method, as recited in claim 16, wherein at regular scheduled time intervals said basic version of said at least two versions of said firmware image and said at least one firmware image difference are transmitted from a regional head end through DVB standard.

19. The digital video broadcasting method, as recited in claim 11, wherein at regular scheduled time intervals of said first version of said firmware image and said firmware image difference are transmitted according to a predetermined data carousel architecture from a regional head end through DVB standard.

20. The digital video broadcasting method, as recited in claim 18, wherein at regular scheduled time intervals said first version of said firmware image and said firmware image difference are transmitted according to a predetermined data carousel architecture from a regional head end through DVB standards.

21. A method for updating a firmware image of a device in digital video broadcasting, comprising:
providing a first version of said firmware image and a second version of said firmware image;
extracting a firmware image difference according to the difference between said first version of said firmware image and said second version of said firmware image; and
transmitting said first version of said firmware image and said firmware image difference from a regional head end through DVB standard.

22. The method, as recited in claim 21, wherein said device is one of a digital set-top box and a digital television.

23. The method, as recited in claim 21, wherein said first version of a firmware image and said second version of said firmware image are digital television (DTV) firmware images.

24. The method, as recited in claim 22, wherein said first version of a firmware image and said second version of said firmware image are digital television (DTV) firmware images.

25. The method, as recited in claim 21, wherein said device contains a loader information stored in a memory inside said device, which is utilized to decide which version of said firmware image or firmware image difference is to be loaded.

26. The method, as recited in claim 24, wherein said device contains a loader information stored in a memory inside said device, which is utilized to decide which version of said firmware image or firmware image difference is to be loaded.

27. The method, as recited in claim 21, wherein at regular scheduled time intervals said first version of said firmware image and said firmware image difference are transmitted from a regional head end through DVB standard.

28. The method, as recited in claim 26, wherein at regular scheduled time intervals said first version of said firmware image and said firmware image difference are transmitted from a regional cable head end through DVB standards.

29. The method, as recited in claim 21, wherein at regular scheduled time intervals of said first version of said firmware image and said firmware image difference are transmitted according to a predetermined data carousel architecture from a regional head end through DVB standard.

30. The method, as recited in claim 28, wherein at regular scheduled time intervals said first version of said firmware image and said firmware image difference are transmitted according to a predetermined data carousel architecture from a regional head end through DVB standards.

31. A method for updating a firmware image of a device in digital video broadcasting, comprising:
receiving a first version of said firmware image and a firmware image difference from a regional head end through DVB standard, within a firmware image difference derived from the difference between said first version and a second version of said firmware image; and
updating said firmware image of said device by said first version of said firmware image and said firmware image difference.

32. The method, as recited in claim 31, wherein said device is one of a digital set-top box and a digital television.

33. The method, as recited in claim 31, wherein said first version of a firmware image and said second version of said firmware image are digital television (DTV) firmware images.

34. The method, as recited in claim 32, wherein said first version of a firmware image and said second version of said firmware image are digital television (DTV) firmware images.

35. The method, as recited in claim 31, wherein said device contains a loader information stored in a memory inside said device, which is utilized to decide which version of said firmware image or firmware image difference is to be loaded.

36. The method, as recited in claim 34, wherein said device contains a loader information stored in a memory inside said device, which is utilized to decide which version of said firmware image or firmware image difference is to be loaded.

37. The method, as recited in claim 31, wherein at regular scheduled time intervals said first version of said firmware image and said firmware image difference are transmitted from a regional head end through DVB standard.

38. The method, as recited in claim 36, wherein at regular scheduled time intervals said first version of said firmware image and said firmware image difference are transmitted from a regional cable head end through DVB standards.

39. The method, as recited in claim 31, wherein at regular scheduled time intervals of said first version of said firmware image and said firmware image difference are transmitted according to a predetermined data carousel architecture from a regional head end through DVB standard.

40. The method, as recited in claim 38, wherein at regular scheduled time intervals said first version of said firmware image and said firmware image difference are transmitted according to a predetermined data carousel architecture from a regional head end through DVB standards.
